(19) United States
(12) Patent Application Publication
(10) Pub. No.: US 2015/0336227 A1
(43) Pub. Date: Nov. 26, 2015

(54) RECONFIGURABLE FIXTURE FOR SHEET METAL PARTS AND METHOD

(71) Applicant: GM GLOBAL TECHNOLOGY OPERATIONS LLC, Detroit, MI (US)

(72) Inventors: Neil David McKay, Chelsea, MI (US); Mark Allen Smith, Huntington Woods, MI (US); Seog-Chan Oh, Troy, MI (US)

(73) Assignee: GM GLOBAL TECHNOLOGY OPERATIONS LLC, Detroit, MI (US)

(21) Appl. No.: 14/708,640

(22) Filed: May 11, 2015

Related U.S. Application Data
(60) Provisional application No. 62/005,239, filed on May 30, 2014.
(60) Provisional application No. 62/000,829, filed on May 20, 2014.

(51) Int. Cl. B23Q 3/08; B23Q 1/38

(52) U.S. Cl. CPC B23Q 3/088; B23Q 1/38

(57) ABSTRACT

A reconfigurable fixture and method for holding a sheet metal part for processing, assembly, or inspection is provided. The reconfigurable fixture includes a holding container made of a flexible material, and holding granules at least partially filling the holding container. The holding container and the holding granules cooperate to conform to the sheet metal part when the sheet metal part is placed on the holding container.

### CROSS-REFERENCE TO RELATED APPLICATIONS

This application claims the benefits of U.S. Provisional Application No. 62/005,239, filed May 30, 2014, and U.S. Provisional Application No. 62/000,829, filed May 20, 2014, which are both hereby incorporated by reference in their entirety.

### TECHNICAL FIELD

This disclosure relates to a reconfigurable fixture for sheet metal parts and a method for the same.

### BACKGROUND

An assembly, such as a vehicle body, is typically comprised of a multitude of sheet metal and/or other parts that must be manufactured, inspected, and assembled to one another with sufficient precision for proper function and aesthetics. Typically, dedicated fixtures are designed and manufactured for positioning, holding, and presenting parts for processing, inspection, or assembly to other parts. These dedicated fixtures may require an extended lead time and a significant capital investment to design and manufacture prior to use. Additionally, the dedicated fixtures may occupy a large amount of manufacturing floor space.

### SUMMARY

A reconfigurable fixture for holding a sheet metal part for processing, assembly, or inspection is provided. The reconfigurable fixture includes a holding container, made of a flexible material, and holding granules at least partially filling the holding container. The holding container and the holding granules cooperate to conform to the sheet metal part when the sheet metal part is placed on the holding container. The reconfigurable fixture may also include a vacuum source operatively connected to the holding container and an air source operatively connected to the holding container. The holding container may be made of a material impermeable to air. The holding container and the holding granules may cooperate to conform to the sheet metal part when air is supplied to the holding container from the air source and the sheet metal part is placed on the holding container. The holding container and the holding granules may cooperate to form a rigid holding shape when the air is removed from the holding container by the vacuum source after the holding container and the holding granules cooperate to conform to the sheet metal part. The reconfigurable fixture may also include a supporting container made of a flexible material, attached to and supporting the holding container, and supporting granules at least partially filling the supporting container. The supporting container and the supporting granules may cooperate to conform to the holding container when the sheet metal part is placed on the holding container.

A second embodiment of the reconfigurable fixture for holding a sheet metal part for processing, assembly, or inspection is also provided. The reconfigurable fixture includes a plurality of holding containers, each made of a flexible material, and holding granules at least partially filling each of the holding containers. The holding containers and the respective holding granules cooperate to conform to a portion of the sheet metal part when the sheet metal part is placed on the holding containers. The reconfigurable fixture may also include a vacuum source operatively connected to each holding container and an air source operatively connected to each holding container. Each holding container may be made of a material impermeable to air. The holding containers and the respective holding granules may cooperate to conform to a portion of the sheet metal part when air is supplied to the holding containers from the air source and the sheet metal part is placed on the holding containers. The holding containers and the respective holding granules may cooperate to form respective rigid holding shapes when the air is removed from the holding containers by the vacuum source after the holding containers and the respective holding granules cooperate to conform to a portion of the sheet metal part.

A method for holding a sheet metal part for processing, assembly, or inspection is also provided. The method includes conforming a flexible holding container at least partially filled with holding granules to the sheet metal part when the sheet metal part is placed on the holding container. The method may also include removing air from the holding container to create a vacuum in the holding container so that the holding container and the holding granules cooperate to form a rigid holding shape after the holding container is conformed to the sheet metal part.

The reconfigurable fixture and method may reduce capital investment and lead time to introduce new vehicle models since dedicated fixtures and clamps for processing, assembly, and inspection of sheet metal parts are not required. Flexible and rapid reconfiguration of fixtures for use with multiple differing sheet metal parts having differing sizes and/or shapes may be enabled. Manufacturing floor space may be reduced since one reconfigurable fixture may replace multiple dedicated fixtures. This disclosure applies to any fixture for positioning, holding, and presenting any part made of any material for processing, inspection, or assembly.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic perspective illustration of a reconfigurable fixture for sheet metal parts showing a sheet metal part being held for processing, assembly, or inspection;

FIG. 1A is a schematic cross-sectional illustration of the reconfigurable fixture for sheet metal parts of FIG. 1 taken at line 1A-1A in FIG. 1 at an edge of the sheet metal part;

FIG. 1B is a schematic cross-sectional illustration of the reconfigurable fixture for sheet metal parts of FIG. 1 taken at line 1B-1B in FIG. 1 at a cutout of the sheet metal part;

FIG. 2 is a schematic perspective illustration of another embodiment of the reconfigurable fixture for sheet metal parts showing the sheet metal part being held for processing, assembly, or inspection;

FIG. 3A is a schematic perspective illustration of the reconfigurable fixture for sheet metal parts of FIG. 1 in a first rigid holding shape;

FIG. 3B is a schematic perspective illustration of the reconfigurable fixture for sheet metal parts of FIG. 1 in a non-rigid and un-conformed shape;

FIG. 3C is a schematic perspective illustration of the reconfigurable fixture for sheet metal parts of FIG. 1 in a second rigid holding shape;

FIG. 4A is a schematic perspective illustration of another embodiment of the reconfigurable fixture for sheet metal parts in a non-rigid and un-conformed shape;

FIG. 4B is a schematic perspective illustration of the reconfigurable fixture for sheet metal parts of FIG. 4A in a rigid holding shape; and

FIG. 5 is flow chart of a method for holding sheet metal parts for processing, assembly, or inspection.

### DETAILED DESCRIPTION

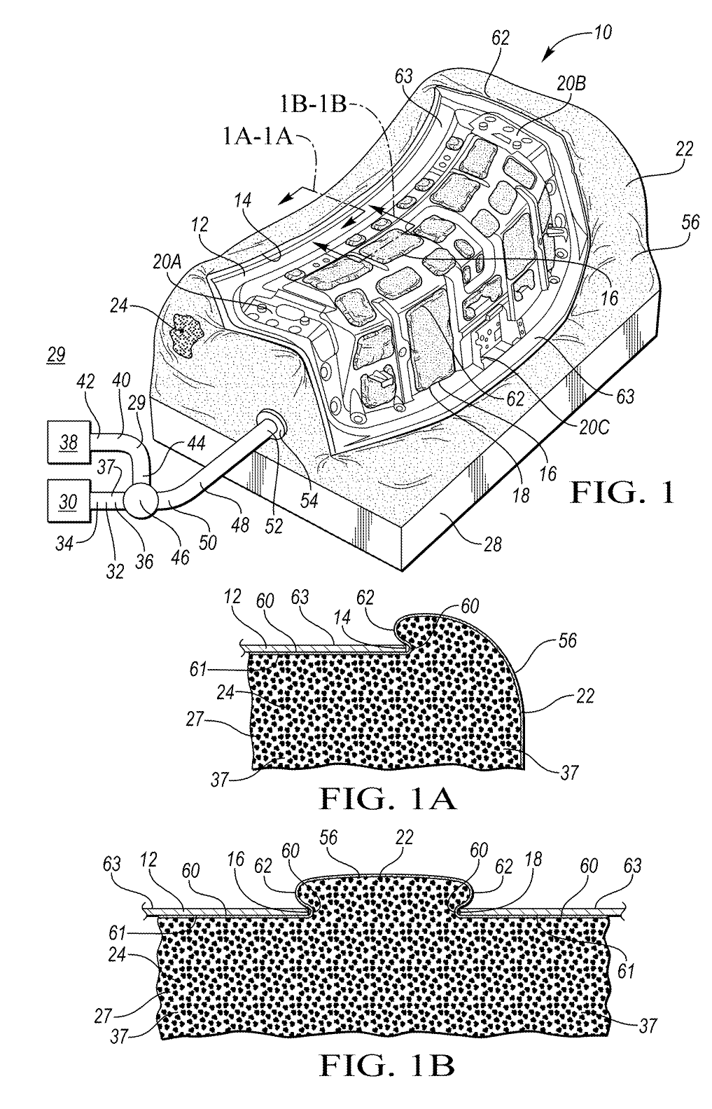

Referring to the drawings, wherein like reference numbers refer to like components throughout the views, FIG. 1 shows a reconfigurable fixture 10 for holding a part 12. The part 12 may be a sheet metal part, such as a deck lid inner, as shown. The part 12 may be made of steel, aluminum, or any other suitable sheet metal or may be made of any other suitable metal or nonmetal material. The part or sheet metal part 12 may be held by the reconfigurable fixture 10 for processing, assembly, or inspection. Multiple subcomponent parts 20A, 20B, 20C, which may be reinforcements for the sheet metal part 12, are also shown. The subcomponent parts 20A, 20B, 20C may be positioned for assembly to the sheet metal part 12 or may already be assembled to the sheet metal part 12. Assembly may include welding, fastening, snap fitting, or any other suitable attachment method. Processing may include forming, punching, cutting, grinding, polishing, or any other part process. Inspection may include manual or machine checking of dimensions, surface conditions, or any other physical property of the part 12. The part 12 includes an edge 14 and a top surface 63. The part 12 may form a cutout 16 having a cutout edge 18.

The reconfigurable fixture 10 includes a holding container or bag 22, made of a flexible material, and holding granules 24 at least partially filling the holding container 22, similar to a bean bag. The holding container 22 may be made of a polymeric material or of another flexible and durable material. The holding container 22 material may be impermeable to air 29 and may be non-flammable. The holding granules 24 may be configured in a variety of shapes, at least some of which may be non-spherical. The holding granules 24 may have first jagged or rough edges 27 and may have a first average diameter or width. The holding granules 24 may be made of a rigid material such as broken ceramic or ground beans. The holding container 22 and the holding granules 24 cooperate to conform to the part or sheet metal part 12 when the sheet metal part 12 is placed on the holding container 22. Placing the sheet metal part 12 on the holding container 22 may include pressing the sheet metal part 12 against the holding container 22 with a force sufficient to conform the holding container 22 to the sheet metal part 12.

The reconfigurable fixture 10 may be attached to a base 28. The base 28 may be stationary. Alternatively, the base 28 may be part of a conveyor or a cart that moves between stations of a manufacturing system. The reconfigurable fixture 10 may be used to support, hold, and present differently-configured sheet metal parts 12 during processing, assembly, or inspection operations. The reconfigurable fixture 10 may also be used to support, hold, and present parts that are made of materials other than sheet metal as well as parts that are configured differently from typical sheet metal parts.

The reconfigurable fixture 10 may include a vacuum source 30 operatively connected to the holding container 22 and an air source 38 operatively connected to the holding container 22. The vacuum source 30 may be a vacuum pump or may be part of a plant vacuum system. The air source 38 may be an air pump or may be part of a plant pressurized air system. Alternatively, the air source 38 may be an opening to the air 29 surrounding the reconfigurable fixture 10. The holding container 22 may include a supply channel connection 54. The operative connection between the vacuum source 30 and the holding container 22 may selectively put the vacuum source 30 into and out of fluid communication with the holding container 22 and may include a vacuum channel 32, a valve 46, a supply channel 48, and the supply channel connection 54. The valve 46 may be a three way valve. The vacuum channel 32 may be a hose, a tube, or a pipe having a first end 34 connected to the vacuum source 30 and a second end 36 connected to the valve 46. The supply channel 48 may be a hose, a tube, or a pipe having a first end 50 attached to the valve 46 and a second end 52 attached to the supply channel connection 54. The operative connection between the air source 38 and the holding container 22 may selectively put the air source 38 into and out of fluid communication with the holding container 22 and may include an air channel 40, the valve 46, the supply channel 48, and the supply channel connection 54. The air channel 40 may be a hose, a tube, or a pipe having a first end 42 connected to the air source 38 and a second end 44 connected to the valve 46. Other configurations of channels and valves may be used to selectively connect and disconnect the vacuum source 30 to the holding container 22 and to selectively connect and disconnect the air source 38 to the holding container 22. For example, the reconfigurable fixture 10 may include multiple vacuum channels 32, air channels 40, valves 46, supply channels 48, and supply channel connections 54.

The holding container 22 and the holding granules 24 may cooperate to conform to the sheet metal part 12 when air 29 is supplied to the holding container 22 from the air source 38 and the sheet metal part 12 is placed on the holding container 22. The holding container 22 and the holding granules 24 may cooperate to form a rigid holding shape 56 when the air 29 is removed from the holding container 22 by the vacuum source 30 creating a vacuum 37 in the holding container 22 after the holding container 22 and the holding granules 24 cooperate to conform to the sheet metal part 12. The holding granules 24 may be pulled against one another and against the holding container 22 due to the removal of the air 29 from the holding container 22, causing the holding container 22 to be pulled against the sheet metal part 12 and causing the holding container 22 in cooperation with the holding granules 24 to form the rigid holding shape 56.

Referring now to FIGS. 1A-1B, the rigid holding shape 56 relationship to the sheet metal part 12 is shown in greater detail. A conforming portion 60 of the holding container 22 in cooperation with the holding granules 24 may conform to a bottom surface 61 and to the edge 14 of the sheet metal part 12. The conforming portion 60 may also conform to other features formed in the sheet metal part 12, including but not limited to, the cutout edges 18, a step-shaped section, an L-shaped section, and a U-shaped section. In addition, an overlapping portion 62 of the holding container 22 in cooperation with the holding granules 24 may overlap, entrap, or capture the top surface 63 of the sheet metal part 12 adjacent to the part edge 14. Similarly, the overlapping portion 62 of the holding container 22 in cooperation with the holding granules 24 may overlap, entrap, or capture the top surface 63 of the sheet metal part 12 adjacent to the cutout edge 18. Although gaps are shown between the holding granules 24 in FIGS. 1A-1B, the holding granules 24 would be tightly packed.

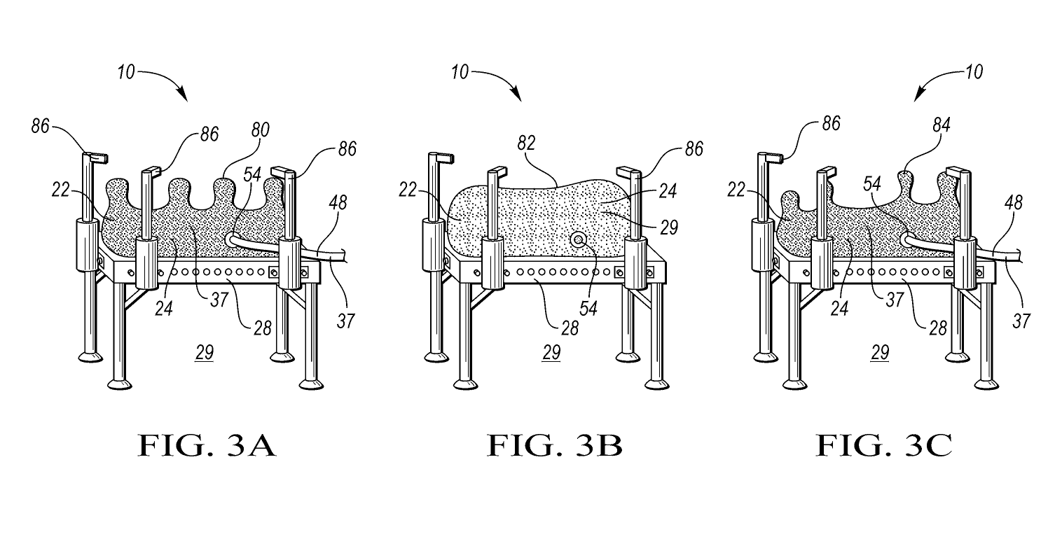

Referring briefly to FIG. 3A, the rigid holding shape 56 may remain unchanged after the air 29 is removed from the holding container 22 creating the vacuum 37 in the holding container 22 and the sheet metal part 12 is removed from the reconfigurable fixture 10 so that a similar sheet metal part 12 can be placed on the holding container 22 and held by the rigid holding shape 56. In this embodiment, the rigid holding shape 56 may not include the overlapping portion 62 that overlaps, entraps, or captures the top surface 63 of the sheet metal part 12. The reconfigurable fixture 10 may include a mounting member 86 attached to the base 28. A clamp (not shown) may be mounted to the mounting member 86. The clamp may hold the sheet metal part 12 against the rigid holding shape 56 when the clamp is in an actuated state. The sheet metal part 12 may be removable from the rigid holding shape 56 when the clamp is in an unactuated state. The rigid holding shape 56 may remain unchanged after the sheet metal part 12 is removed from the reconfigurable fixture 10 so that a similar sheet metal part 12 can be placed on the holding container 22 and held by the rigid holding shape 56 and the actuated clamp.

Returning to FIGS. 1-1A, the holding container 22 and the holding granules 24 may cooperate to grip the sheet metal part 12 when the holding container 22 and the holding granules 24 cooperate to form the rigid holding shape 56, preventing movement of the sheet metal part 12 relative to the reconfigurable fixture 10. Gripping of the sheet metal part 12 may result from friction between the conforming portion 60 of the holding container 22 and one of the part edge 14, the cutout edge 18, and other features formed in the sheet metal part 12, including but not limited to, step-shape sections, L-shaped sections, and U-shaped sections. Gripping of the sheet metal part 12 may result from overlap, entrapment, or capture of the sheet metal part 12 by the overlapping portion 62 of the holding container 22 in cooperation with the holding granules 24. Gripping of the sheet metal part 12 may result from a vacuum created by contact between the conforming portion 60 of the holding container 22 and the sheet metal part 12.

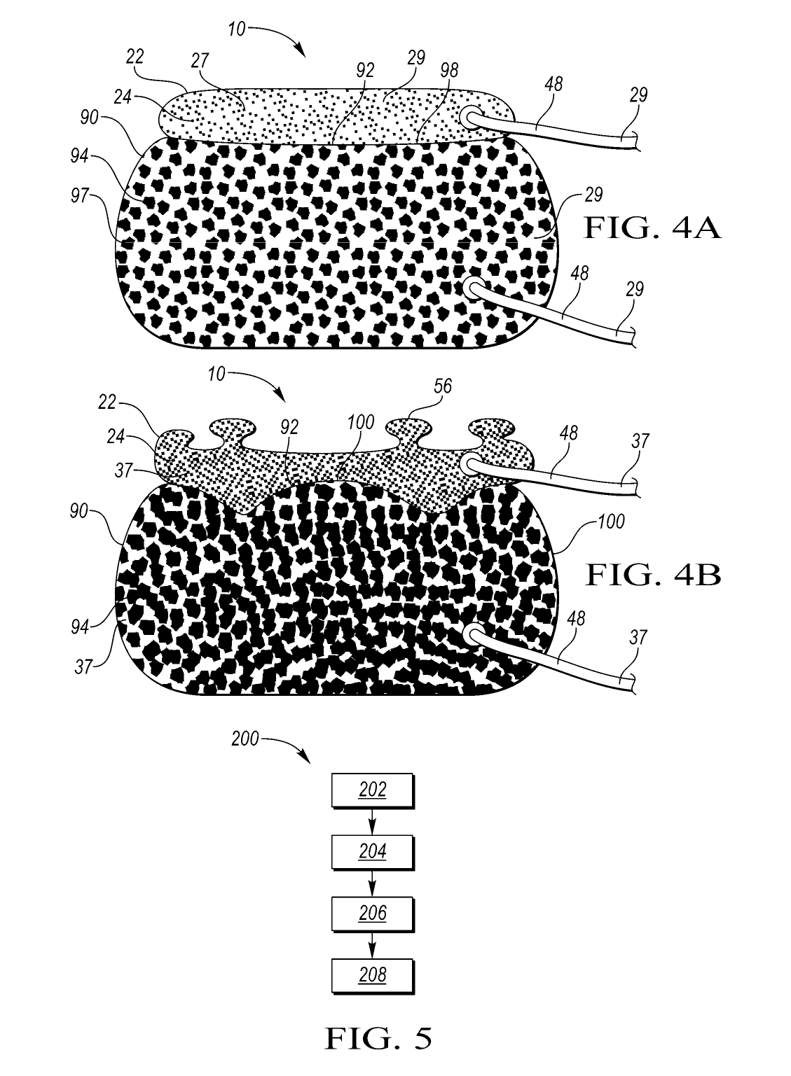

Referring now to FIGS. 4A-4B, in another embodiment, the reconfigurable fixture 10 may include a supporting container 90, made of a flexible material and supporting the holding container 22, and supporting granules 94 at least partially filling the supporting container 90. The supporting container 22 may be attached to the holding container 22 at an attachment 92. The supporting container 90 and the supporting granules 94 may cooperate to conform to the holding container 22 when the sheet metal part 12 is placed on the holding container 22.

The reconfigurable fixture 10 may include a vacuum source 30 operatively connected to the holding container 22 and to the supporting container 90 and an air source 38 operatively connected to the holding container 22 and to the supporting container 90 in a manner similar to that described above with reference to FIG. 1. The holding container 22 and the supporting container 90 may be made of a material that is impermeable to air. The holding container 22 and the supporting container 90 may be made of a material that is non-flammable. The supporting granules 94 may be a variety of shapes, at least some of which may be non-spherical. The supporting granules 94 may have second jagged or rough edges 97 and may have a second average diameter or width. The second average diameter or width may be larger than the first average diameter or width.

The holding container 22 and the holding granules 24 may cooperate to conform to the sheet metal part 12 and the supporting container 90 and the supporting granules 94 may cooperate to conform to the holding container 22 when air 29 is supplied to the holding container 22 and to the supporting container 90 by the air source 38 and the sheet metal part 12 is placed on the holding container 22. The holding container 22 and the holding granules 24 may cooperate to form a rigid holding shape 56 and the supporting container 90 and the supporting granules 94 may cooperate to form a rigid supporting shape 100 when the air 29 is removed from the holding container 22 and the supporting container 90 by the vacuum source 30 after the holding container 22 and the holding granules 24 cooperate to conform to the sheet metal part 12 and the supporting container 90 and the supporting granules 94 cooperate to conform to the holding container 22. The supporting container 90 cooperating with the supporting granules 94 may support the holding container 22 on a conforming surface 98 of the supporting container 90. The holding container 22 and the holding granules 24 having the first jagged or rough edges 27 may cooperate to provide a higher interlocking force, while the supporting container 90 and the supporting granules 94 having the second jagged or rough edges 97 may cooperate to provide a stronger supporting structure.

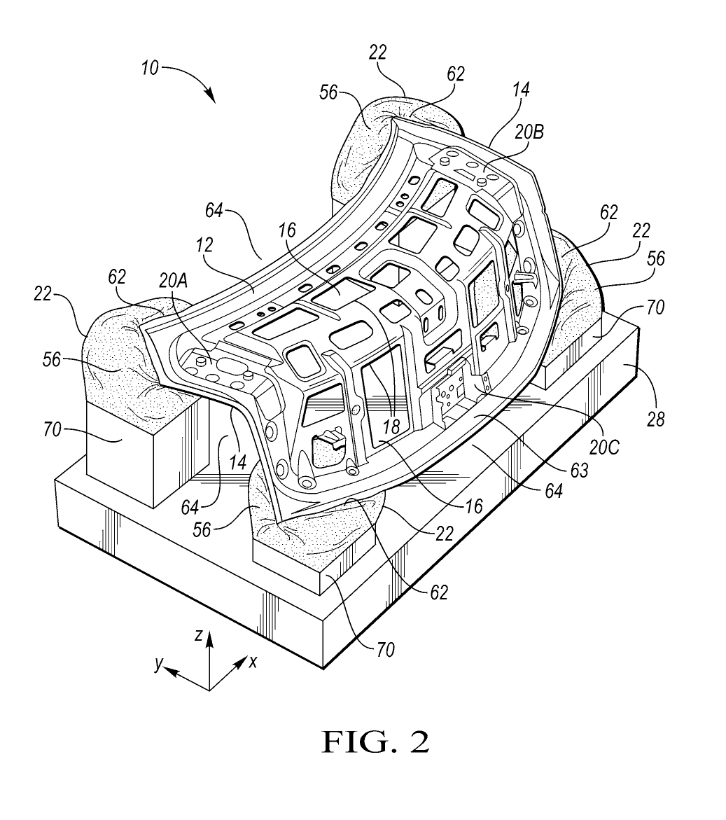

Referring now to FIG. 2, in another embodiment, the reconfigurable fixture 10 for holding a sheet metal part 12 includes a plurality of holding containers 22, each made of a flexible material, and holding granules 24 at least partially filling each of the holding containers 22. The holding containers 22 and the respective holding granules 24 cooperate to conform to at least a portion of the sheet metal part 12 when the sheet metal part 12 is placed on the holding containers 22. An access space 64 formed between the holding containers 22 may allow improved sheet metal part 12 access for processing, assembly, and inspection tools and operations.

The reconfigurable fixture 10 may include a vacuum source 30 operatively connected to each holding container 22 and an air source 38 operatively connected to each holding container 22 in a manner similar to that described above with reference to FIG. 1. Each holding container 22 may be made of a material impermeable to air 29. The holding containers 22 and the respective holding granules 24 may cooperate to conform to a portion of the sheet metal part 12 when air 29 is supplied to the holding containers 22 from the air source 38 and the sheet metal part 12 is placed on the holding containers 22. The holding containers 22 and the respective holding granules 24 cooperate to form respective rigid holding shapes 56 when the air 29 is removed from the holding containers 22 by the vacuum source 30 after the holding containers 22 and the respective holding granules 24 cooperate to conform to a portion of the sheet metal part 12.

The rigid holding shapes 56 may remain unchanged when the air 29 is removed from the holding containers 22 and the sheet metal part 12 is removed from the reconfigurable fixture 10 so that a similar sheet metal part 12 can be placed on the holding containers 22 and held by the rigid holding shapes 56.

The holding containers 22 and the respective holding granules 24 may cooperate to grip the sheet metal part 12 when the holding containers 22 and the respective holding granules 24 cooperate to form the respective rigid holding shapes 56, preventing movement of the sheet metal part 12 relative to the reconfigurable fixture 10, as described above with reference to FIGS. 1-1A. The reconfigurable fixture 10 may include a plurality of supporting containers 90, each made of a flexible material and supporting a respective holding container 22, and supporting granules 94 at least partially filling each of the supporting container 90, as described above in reference to FIGS. 4A-4B.

The reconfigurable fixture 10 may also include one or more actuators 70 attached to one or more of the holding containers 22 and to the base 28. The one or more actuators 70 may reposition the holding container 22 in one or more of directions X, Y, and Z. Alternatively, the holding container 22 may be manually repositioned in one or more of the directions X, Y, and Z. The actuator 70 may reposition the holding container 22 to accommodate a size and/or a shape of the sheet metal part 12 before the sheet metal part 12 is placed on the holding containers 22.

The actuator 70 may reposition the holding container 22 to adjust the shape of the sheet metal part 12 after the holding containers 22 and the respective holding granules 24 cooperate to form respective rigid holding shapes 56 when the air 29 is removed from the holding containers 22 by the vacuum source 30.

Referring now to FIGS. 3A-3C, the reconfigurable fixture 10 base 28 may include the mounting members 86 attached to the base 28. Vision cameras, sensors, mechanical clamps, and process, assembly, and inspection tools may be attached to the mounting members 86. FIG. 3A shows the reconfigurable fixture 10 when the air 29 is removed from the holding container 22 and the holding container 22 cooperates with the granules 24 to maintain a first rigid holding shape 80 when the sheet metal part 12 is removed. In this state, a similar sheet metal part 12 can be placed on the holding container 22 and held by the first rigid holding shape 80.

To reconfigure the reconfigurable fixture 10, the vacuum source 30 is disconnected and the air source 38 is connected to the holding container 22. As shown in FIG. 3B, the holding container 22 cooperates with the holding granules 24 to form a non-rigid and un-conformed shape 82. In this state, the holding granules 24 and the holding container 22 are relaxed and can be reshaped.

When a different sheet metal part (not shown) having a different size and/or shape than that of the sheet metal part 12 is placed on the holding container 22 and the holding container 22 cooperates with the holding granules 24 to conform to the different sheet metal part, the air source 38 may be disconnected and the vacuum source 30 may be connected to the holding container 22, causing the holding container 22 and the holding granules 24 to cooperate to form a second rigid holding shape 84. FIG. 3C shows the reconfigurable fixture 10 when the air 29 is removed from the holding container 22 and the holding container 22 cooperates with the holding granules 24 to maintain the second rigid holding shape 84 when the different sheet metal part is removed.

Referring now to FIG. 5, a method 200 for holding a sheet metal part 12 for processing, assembly, or inspection includes conforming 202 a flexible holding container 22 at least partially filled with holding granules 24 to the sheet metal part 12 when the sheet metal part 12 is placed on the holding container 22. The method 200 may include removing 204 air 29 from the holding container 22 to create the vacuum 37 in the holding container 22 so that the holding container 22 and the holding granules 24 cooperate to form a rigid holding shape 56 after the holding container 22 is conformed to the sheet metal part 12. The method 200 may include maintaining 206 the rigid holding shape 56 when the sheet metal part 12 is removed from the holding container 22 by maintaining the vacuum 37 in the holding container 22 so that a similar sheet metal part 12 can be placed on the holding container 22 and held by the rigid holding shape 56. The method 200 may include supplying 208 air 29 to the holding container 22 so that the rigid holding shape 56 is not maintained and the holding container 22 will conform to a different sheet metal part when the different sheet metal part is placed on the holding container 22.

Conforming 202 may include conforming a supporting container 90 at least partially filled with supporting granules 94 to support the holding container 22 when the sheet metal part 12 is placed on the holding container 22. Conforming 202 may include conforming a plurality of flexible holding containers 22, each at least partially filled with holding granules 24, to a sheet metal part 12 when the sheet metal part 12 is placed on the holding containers 22.

This disclosure applies to the manufacture, processing, assembly, and/or inspection of any machine or manufacture. Non-limiting examples include vehicles, buildings (such as pre-fab assemblies for homes and offices), aircraft, household appliances, consumer products, office products, furniture, HVAC systems, industrial equipment, etc.

While the best modes for carrying out the many aspects of the present teachings have been described in detail, those familiar with the art to which these teachings relate will recognize various alternative aspects for practicing the present teachings that are within the scope of the appended claims.

1. A reconfigurable fixture for holding a sheet metal part for processing, assembly, or inspection, comprising:
a holding container made of a flexible material; and
holding granules at least partially filling the holding container;
wherein the holding container and the holding granules cooperate to conform to the sheet metal part when the sheet metal part is placed on the holding container.

2. The reconfigurable fixture of claim 1, further comprising:
a vacuum source operatively connected to the holding container; and
an air source operatively connected to the holding container;
wherein the holding container is made of a material impermeable to air;
wherein the holding container and the holding granules cooperate to conform to the sheet metal part when air is supplied to the holding container from the air source and the sheet metal part is placed on the holding container; and
wherein the holding container and the holding granules cooperate to form a rigid holding shape when the air is removed from the holding container by the vacuum source after the holding container and the holding granules cooperate to conform to the sheet metal part.

3. The reconfigurable fixture of claim 2, further comprising a clamp;
wherein the clamp holds the sheet metal part against the rigid holding shape when the clamp is in an actuated state;
wherein the sheet metal part is removable from the rigid holding shape when the clamp is in an unactuated state; and
wherein the rigid holding shape remains unchanged after the sheet metal part is removed from the reconfigurable fixture.

4. The reconfigurable fixture of claim 2, wherein the holding container and the holding granules cooperate to grip the sheet metal part when the holding container and the holding granules cooperate to form the rigid holding shape, preventing movement of the sheet metal part relative to the reconfigurable fixture.

5. The reconfigurable fixture of claim 2, further comprising a valve for controlling one of the air source and the vacuum source.

6. The reconfigurable fixture of claim 1, further comprising:
a supporting container made of a flexible material and attached to and supporting the holding container; and
supporting granules at least partially filling the supporting container;
wherein the supporting container and the supporting granules cooperate to conform to the holding container when the sheet metal part is placed on the holding container.

7. The reconfigurable fixture of claim 6, further comprising:
a vacuum source operatively connected to the holding container and to the supporting container; and
an air source operatively connected to the holding container and to the supporting container; and
wherein the holding container and the supporting container are made of a material impermeable to air;
wherein the holding container and the holding granules cooperate to conform to the sheet metal part and the supporting container and the supporting granules cooperate to conform to the holding container when air is supplied to the holding container and to the supporting container by the air source and the sheet metal part is placed on the holding container; and
wherein the holding container and the holding granules cooperate to form a rigid holding shape and the supporting container and the supporting granules cooperate to form a rigid supporting shape when the air is removed from the holding container and the supporting container by the vacuum source after the holding container and the holding granules cooperate to conform to the sheet metal part and the supporting container and the supporting granules cooperate to conform to the holding container.

8. The reconfigurable fixture of claim 7, further comprising a valve for controlling one of the air source and the vacuum source.

9. A reconfigurable fixture for holding a sheet metal part, comprising:
a plurality of holding containers, each made of a flexible material; and
holding granules at least partially filling each of the holding containers;
wherein the holding containers and the respective holding granules cooperate to conform to at least a portion of the sheet metal part when the sheet metal part is placed on the holding containers.

10. The reconfigurable fixture of claim 9, further comprising:
a vacuum source operatively connected to each holding container; and
an air source operatively connected to each holding container;
wherein each holding container is made of a material impermeable to air;
wherein the holding containers and the respective holding granules cooperate to conform to a portion of the sheet metal part when air is supplied to the holding containers from the air source and the sheet metal part is placed on the holding containers; and
wherein the holding containers and the respective holding granules cooperate to form respective rigid holding shapes when the air is removed from the holding containers by the vacuum source after the holding containers and the respective holding granules cooperate to conform to a portion of the sheet metal part.

11. The reconfigurable fixture of claim 10, wherein the rigid holding shapes remain unchanged when the air is removed from the holding containers and the sheet metal part is removed from the reconfigurable fixture.

12. The reconfigurable fixture of claim 10, wherein the holding containers and the respective holding granules cooperate to grip the sheet metal part when the holding containers and the respective holding granules cooperate to form the respective rigid holding shapes, preventing movement of the sheet metal part relative to the reconfigurable fixture.

13. The reconfigurable fixture of claim 10, further comprising a valve for controlling one of the air source and the vacuum source.

14. The reconfigurable fixture of claim 9, further comprising an actuator attached to one of the holding containers.

15. The reconfigurable fixture of claim 14, wherein the actuator repositions the holding container to accommodate the sheet metal part before the sheet metal part is placed on the holding containers.

16. The reconfigurable fixture of claim 10, further comprising an actuator attached to one of the holding containers;
wherein the actuator repositions the holding container to adjust a shape of the sheet metal part after the holding containers and the respective holding granules cooperate to form respective rigid holding shapes when the air is removed from the holding containers by the vacuum source.

17. A method for holding a sheet metal part for processing, assembly, or inspection, comprising:
conforming a flexible holding container at least partially filled with holding granules to the sheet metal part when the sheet metal part is placed on the holding container.

18. The method of claim 17, further comprising removing air from the holding container to create a vacuum in the holding container so that the holding container and the holding granules cooperate to form a rigid holding shape after the holding container is conformed to the sheet metal part.

19. The method of claim 18, further comprising maintaining the rigid holding shape when the sheet metal part is removed from the holding container by maintaining the vacuum in the holding container so that a similar sheet metal part can be placed on the holding container and held by the rigid holding shape.

20. The method of claim 18, further comprising supplying air to the holding container so that the rigid holding shape is not maintained and the holding container will conform to a different sheet metal part when the different sheet metal part is placed on the holding container.
